(19) United States
(12) Patent Application Publication
(10) Pub. No.: US 2026/0251460 A1
(43) Pub. Date: Aug. 27, 2026

(54) VEHICLE POSITION ESTIMATION DEVICE AND VEHICLE POSITION ESTIMATION METHOD

(71) Applicants: DENSO CORPORATION, Kariya-city (JP); J-QuAD DYNAMICS Inc., Tokyo (JP)

(72) Inventor: Yoshiki HAYAKAWA, Tokyo (JP)

(21) Appl. No.: 19/535,810

(22) Filed: Feb. 10, 2026

(30) Foreign Application Priority Data
Feb. 21, 2025 (JP) 2025-026314

(51) Int. Cl. G01C 21/30

(52) U.S. Cl. CPC G01C 21/30

(57) ABSTRACT

A vehicle position estimation device includes: a point cloud acquisition unit, a matching unit, and an estimation unit. The matching unit performs, in a matching process, a first matching process using a first position as an initial position and a second matching process using a second position different from the first position as an initial position. The estimation unit performs at least one of: (a) invalidating at least part of the matching result information in a case that a matching difference information representing the difference between first matched position and second matched position does not satisfy a first condition, and (b) reducing the reliability of the estimated vehicle position obtained by the estimation process compared to in a case that the matching difference information satisfies the first condition.

### CROSS-REFERENCE TO RELATED APPLICATIONS

The present application claims priority to Japanese Application No. 2025-26314, filed on February 21, 2025. The contents of this application are incorporated herein by reference in their entirety.

### BACKGROUND

### 1. Technical Field

The present disclosure relates to a vehicle position estimation device and a vehicle position estimation method.

### 2. Related Art

Regarding vehicle position estimation, JP2020038200A discloses a technique for determining a vehicle's position by matching the coordinates of landmarks contained in map information with the coordinates of landmarks calculated based on data acquired in real time by sensors.

### SUMMARY

According to one aspect of the present disclosure, a vehicle position estimation device (100) is provided. This vehicle position estimation device comprises:

a point cloud acquisition unit (150) configured to acquire environmental point cloud data (EP) representing a surrounding environment of a vehicle (50) using sensors mounted to the vehicle, a matching unit (160) configured to perform a matching process between the acquired environmental point cloud data and recorded point cloud data (RP), and an estimation unit (170) configured to perform an estimation process to estimate a vehicle position that is a position of the vehicle based on a matching result information of the matching process. The matching unit is configured to perform, in the matching process, a first matching process using a first position as an initial position and a second matching process using a second position different from the first position as an initial position. The matching result information includes a first matched position that is a result of the first matching process and a second matched position that is a result of the second matching process. The estimation unit performs at least one of: (a) invalidating at least part of the matching result information in a case that a matching difference information representing the difference between first matched position and second matched position does not satisfy a first condition, and (b) reducing the reliability of the estimated vehicle position obtained by the estimation process compared to in a case that the matching difference information satisfies the first condition.

### BRIEF DESCRIPTION OF THE DRAWING

FIG. 1 is a diagram showing a schematic configuration of a driving support system according to a first embodiment.

FIG. 2 is a diagram illustrating a matching process according to the first embodiment.

FIG. 3 is a diagram illustrating a recording process.

FIG. 4 is a flowchart of a vehicle position estimation process according to the first embodiment.

FIG. 5 is a flowchart of the vehicle position estimation process according to a second embodiment.

FIG. 6 is a diagram illustrating a matching process according to the second embodiment.

FIG. 7 is a flowchart of a vehicle position estimation process according to a third embodiment.

FIG. 8 is a flowchart of a vehicle position estimation process according to a fourth embodiment.

FIG. 9 is a flowchart of a vehicle position estimation process according to a fifth embodiment.

FIG. 10 is a diagram illustrating a matching process according to a sixth embodiment.

FIG. 11 is a flowchart of a vehicle position estimation process according to the sixth embodiment.

### DETAILED DESCRIPTION OF THE PREFERRED EMBODIMENTS

Point cloud matching processes such as ICP (Iterative Closest Point) are used for estimating vehicle position. In such a point cloud matching process, environmental point cloud data representing a surrounding environment of the vehicle acquired by sensors is matched with recorded point cloud data. However, when the surrounding environment is relatively featureless, the environmental point cloud data and the recorded point cloud data may be matched at positions different from the true positions even if the matching residual is relatively small. This can result in an inappropriate matching result. Using such an inappropriate matching result for vehicle position estimation may potentially cause the subsequent process utilizing the estimated vehicle position to be affected.

The present disclosure may be realized in the following embodiments.

According to one aspect of the present disclosure, a vehicle position estimation device (100) is provided. This vehicle position estimation device comprises:

a point cloud acquisition unit (150) configured to acquire environmental point cloud data (EP) representing a surrounding environment of a vehicle (50) using sensors mounted to the vehicle, a matching unit (160) configured to perform a matching process between the acquired environmental point cloud data and recorded point cloud data (RP), and an estimation unit (170) configured to perform an estimation process to estimate a vehicle position that is a position of the vehicle based on a matching result information of the matching process. The matching unit is configured to perform, in the matching process, a first matching process using a first position as an initial position and a second matching process using a second position different from the first position as an initial position. The matching result information includes a first matched position that is a result of the first matching process and a second matched position that is a result of the second matching process. The estimation unit performs at least one of: (a) invalidating at least part of the matching result information when a matching difference information representing the difference between first matched position and second matched position does not satisfy a first condition, and (b) reducing the reliability of the estimated vehicle position obtained by the estimation process compared to when the matching difference information satisfies the first condition.

According to this configuration, when the matching difference information does not satisfy the first condition, at least one of invalidating matching result information and reducing the reliability of the estimated result obtained using matching result information is performed. This suppresses the adverse effects of an inappropriate matching result information on subsequent processes that use the estimated vehicle position result.

### A. First Embodiment:

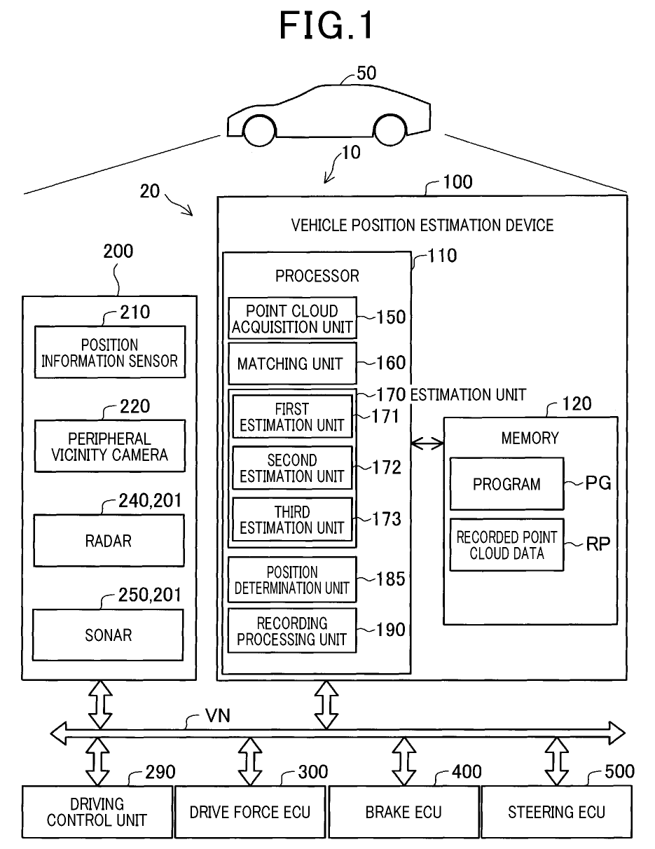

As shown in FIG. 1, a driving support system 10 is mounted to the vehicle 50. The driving support system 10 is provided with a vehicle position estimation system 20. The vehicle position estimation system 20 is provided with a vehicle position estimation device 100 and sensors 200. The vehicle position estimation device 100 is used to estimate a vehicle position representing a position of the vehicle 50. The vehicle position is also referred to as the "own vehicle position."

The vehicle 50 is controlled by the driving assistance system 10 to perform autonomous driving functions by an ADAS (Advanced Driving Assistant System). The autonomous driving function enables autonomous travelling of the vehicle 50 and includes collision detection, automatic braking, and automatic steering. In this embodiment, the autonomous driving function is used for parking assistance to automatically park the vehicle 50 in a desired parking space. In this disclosure, the meaning of parking assistance includes not only narrowly defined parking assistance, which guides the vehicle 50 from a location relatively close to the parking space (such as private property near the parking space) to the parking space itself, but also broadly defined parking assistance, which guides the vehicle 50 from a location relatively far from the parking space (such as a public road) to the parking space.

The driving support system 10 is further provided with a driving control unit 290, a drive force ECU (Electronic Control Unit) 300, a brake ECU 400, and a steering ECU 500. The vehicle position estimation device 100, the sensors 200, the driving control unit 290, the drive force ECU 300, the brake ECU 400, and the steering ECU 500 are connected via an in-vehicle network VN. The in-vehicle network VN is, for example, a Controller Area Network (CAN).

The driving control unit 290 is configured as a computer including a processor and a memory. The processor executes a program stored in the memory to realize driving control functions that control the drive force ECU 300, the brake ECU 400, and the steering ECU 500. The drive force ECU 300 controls the operating state of a power source of the vehicle 50. The brake ECU 400 controls the operation state of a brake mechanism of the vehicle 50. The steering ECU 500 controls the operation state of a steering mechanism of the vehicle 50.

The sensors 200 include at least a ranging sensor 201 as a sensor for acquiring environmental point cloud data EP. The environmental point cloud data EP represents a surrounding environment of the vehicle 50. In this embodiment, the sensors 200 include a radar 240 and a sonar 250 as the ranging sensor 201. In other embodiments, the ranging sensor 201 may include, for example, a LiDAR (Light Detection and Ranging), and is not limited to radar 240 or sonar 250.

In this embodiment, the sensors 200 include, in addition to the radar 240 and sonar 250 described above as the ranging sensors 201, a position information sensor 210 and a peripheral vicinity camera 220.

The position information sensor 210 includes devices constituting the Global Navigation Satellite System (GNSS). In this embodiment, the position information sensor 210 includes devices constituting the Global Positioning System (GPS) and includes a receiver for the GPS satellite signals, etc. Instead of the GPS, any other type of the GNSS, such as the Quasi-Zenith Satellite System (QZSS), the GLONASS (Global Navigation Satellite System), or the Galileo, may be used. The position information from the position information sensor 210 is used to obtain a second estimated position. The second estimated position is the vehicle position estimated using the position information sensor 210. The second estimated position may generally include an error of tens of centimeters to several meters.

The peripheral vicinity camera 220 images surrounding vicinity of the vehicle 50 to obtain images. The image range of the peripheral vicinity camera 220 may be, for example, to image the road surface within a range of approximately 5 meters (m) radius centered on the vehicle 50. The peripheral vicinity camera 220 may be, for example, placed on the front grille or side mirrors of the vehicle 50.

The radar 240 transmits probe waves of a predetermined wavelength, such as millimeter waves or quasi-millimeter waves, and detects the relative position and relative velocity of obstacles with respect to the vehicle 50 by receiving and analyzing the reflected waves. The radar 240 is positioned on the front grille or front bumper of the vehicle 50. The sonar 250 transmits sound waves as probe waves and detects the relative position and relative speed of obstacles relative to the vehicle 50 by receiving and analyzing the reflected waves. The sonar 250 is positioned on the front grille or front bumper of the vehicle 50.

In another embodiments, the sensors 200 may include various sensors such as a forward camera, LiDAR, or peripheral cameras, without being limited to the above. The forward camera captures images of the area in front of the vehicle 50 within a predetermined field of view. The LiDAR transmits pulsed laser light as probe waves, receives the reflected waves, and analyzes them to detect the relative position and relative velocity of obstacles with respect to the vehicle 50. The peripheral camera images surrounding space of the vehicle 50, like the peripheral vicinity camera 220. The peripheral camera may image a wider area at higher resolution than the peripheral vicinity camera 220.

In this embodiment, the vehicle position estimation device 100 is configured as an ECU (Electronic Control Unit) comprising a processor 110 and a memory 120 including a ROM and a RAM. As described above, the vehicle position estimation device 100 communicates with each sensor constituting the sensors 200 via the vehicle network VN. The memory 120 stores various information, such as a program PG and recorded point cloud data RP, pre-recorded therein. By executing the program PG stored in the memory 120, the processor functions as a point cloud acquisition unit 150, a matching unit 160, an estimation unit 170, a position determination unit 185, and a recording processing unit 190.

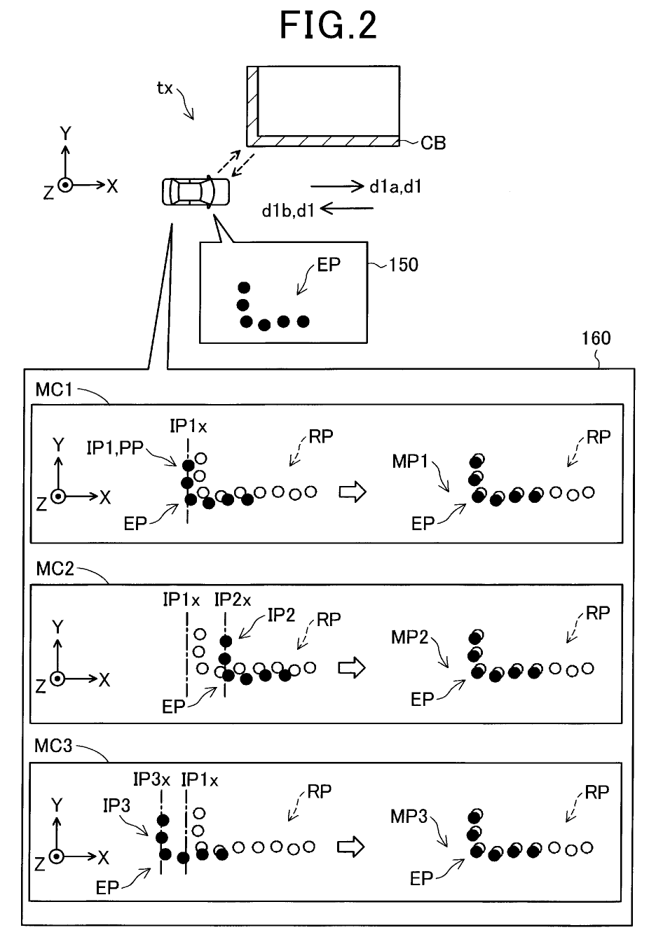

As shown in FIG. 2, the point cloud acquisition unit 150 acquires environmental point cloud data EP using the sensors 200. In this embodiment, the environmental point cloud data EP is acquired as point cloud data representing the surrounding environment of the vehicle 50 at timing tx. The environmental point cloud data EP may be point cloud data generated by fusing detection results of the sensors 200. In this embodiment, the environmental point cloud data EP is acquired by first obtaining first fusion information through fusion of imaging data from the peripheral vicinity camera 220 and ranging results from the sonar 250, and then further fusing the ranging results from the radar 240 with the first fusion information. Acquiring the environmental point cloud data EP by utilizing detection results of multiple sensors in this manner enables higher accuracy of the environmental point cloud data EP. The environmental point cloud data EP is used to acquire the matching difference information described later. In the example of FIG. 2, the environmental point cloud data EP represents a curb CB.

FIG. 2 shows arrows indicating mutually orthogonal X, Y, and Z directions. The X, Y, and Z directions correspond to the directions along the X, Y, and Z axes, respectively. Each of the X and Y directions is parallel to the horizontal plane, and the Z direction is aligned vertically upward. Coordinate values on the X, Y, and Z axes are also referred to as X, Y, and Z coordinate values, respectively. Arrows indicating the X, Y, and Z directions are also shown in other figures, with their directions corresponding to those in FIG. 2. In the following description, when specifying the orientation of a direction, the direction indicated by the arrow in each figure is designated as “+”, and the opposite direction is designated as “−”. Positive and negative signs are used together in the direction notation.

In this embodiment, the environmental point cloud data EP is two-dimensional point cloud data containing positional information in the X and Y directions but not in the Z direction. In another embodiment, the environmental point cloud data EP may be, for example, three-dimensional point cloud data.

The matching unit 160 shown in FIG. 1 performs a matching process. The matching process is a process of matching the environmental point cloud data EP acquired by the point cloud acquisition unit 150 with the recorded point cloud data RP. In FIG. 2, point cloud contained in the environmental point cloud data EP is shown by black-painted circles, and point cloud contained in the recorded point cloud data RP is shown by white-painted circles. Hereinafter, "matching between the environmental point cloud data EP and the recorded point cloud data RP" is also referred to as “point cloud matching process”. Details of the recorded point cloud data RP will be described later. In this embodiment, the ICP (Iterative Closest Point) algorithm is used for the point cloud matching process. In another embodiments, various algorithms, such as NDT (Normal Distributions Transform), may be used for the point cloud matching process algorithm, not limited to ICP.

As shown in FIG. 2, in this embodiment, the matching unit 160 performs multiple point cloud matching process, including point cloud matching process MC1, MC2, and MC3, in the matching process. Each of the point cloud matching process MC1, MC2, and MC3 is a point cloud matching process that use mutually different positions IP1, IP2, and IP3 as initial matching positions. The respective initial matching position is an initial position of the point cloud matching process. More specifically, the initial matching position for one point cloud matching process corresponds to a position within that point cloud matching process where the matching process of the environmental point cloud data EP with the recorded point cloud data RP starts. In this embodiment, the initial matching position is represented by X, Y coordinate values indicating an arbitrary location on the recorded point cloud data RP that is point cloud map data. Each of the point cloud matching process MC1, MC2, and MC3 is performed to obtain the matching difference information described later.

By performing the point cloud matching process, a matched position that is a result of the point cloud matching process is output. The matched position by the point cloud matching process represents the position where the environmental point cloud data EP and the recorded point cloud data RP matched within the point cloud matching process, i.e., the position where the point cloud matching process converged. FIG. 2 shows the matched positions MP1, MP2, and MP3 output by the point cloud matching process MC1, MC2, and MC3, respectively. In this embodiment, the matched position is represented by X and Y coordinate values indicating a point on the recorded point cloud data RP.

When the point cloud matching process MC1 is defined as a first matching process, each of the point cloud matching processes MC2 and MC3 is defined as a second matching process. The first matching process is a point cloud matching process performed with the first position as the initial matching position. The second matching process is a point cloud matching process performed with a second position, different from the first position, as the initial matching position. For example, when the point cloud matching process MC2 is defined as the first matching process, the point cloud matching process MC3 is defined as the second matching process.

In this embodiment, the positions IP2 and IP3 are positions displaced from the position IP1 in the forward or backward direction d1 of vehicle 50. Therefore, in this embodiment, the second position is a position displaced from the first position in the forward or backward direction d1. In the example of FIG. 2, the forward or backward direction d1 is along the X-direction. In the example of FIG. 2, the forward direction d1a parallel with the longitudinal direction d1 is the +X direction, and the backward direction d1b parallel with the longitudinal direction d1 is the -X direction. The position IP2 is at a position in the +X direction relative to position IP1. Therefore, as shown in FIG. 2, the X-coordinate value IP2x of the position IP2 is greater than the X-coordinate value IP1x of the position IP1. The position IP3 is at a position in the -X direction relative to position IP1. Therefore, as shown in FIG. 2, the X-coordinate value IP3x of the position IP3 is smaller than the X-coordinate value IP1x of the position IP1.

The matching unit 160 outputs matching result information, that represents the result of the above matching process, by performing the matching process. The matching result information includes a first matched position and a second matched position. The first matched position represents the matched position obtained by performing the first matching process. The second matched position represents the matched position obtained by performing the second matching process.

In this embodiment, each of the first matched position and the second matched position is represented by X-coordinate values and Y-coordinate values. More specifically, the first matched position is represented by a first X-coordinate value on the X-axis and a first Y-coordinate value on the Y-axis. The second matched position is represented by a second X-coordinate value on the X-axis and a second Y-coordinate value on the Y-axis.

The matching unit 160 acquires matching difference information based on the matching result information. The matching difference information represents a difference between the first matched position and the second matched position. More specifically, in this embodiment, the matching difference information represents the distance between the first matched position and the second matched position. In this embodiment, when three or more point cloud matching processes, including the first matching process and the second matching process, are performed in the matching process, the matching difference information may be represented, for example, as a statistical value of the differences between matched positions in each of the point cloud matching process. The statistical value may be, for example, a maximum value, an average value, or a median value.

In the matching process, the matching unit 160 acquires a provisional position of the vehicle 50. The provisional position is a temporary vehicle position used to determine an initial matching position. In this embodiment, the matching unit 160 acquires the provisional position PP as the provisional position. The provisional position PP is a provisional position at timing tx. The provisional position PP is a position corrected by an amount of movement of the vehicle 50, based on the difference between the most recent timing and timing tx, relative to a recent position at the timing closest to timing tx. In this case, the calculation of the amount of movement of the vehicle 50 may be, for example, performed based on driving parameters of vehicle 50. The driving parameters of the vehicle 50 include parameters related to at least one of the speed, the acceleration, and the steering angle. These parameters may be measured values or control values.

In this embodiment, the matching unit 160 uses different recent positions for an initial process and subsequent processes. The initial process is the matching process performed before a determination process described later is performed. In the initial process, the matching unit 160 uses a second estimated position acquired at a most recent timing as the recent position. Each of the sequential processes is the matching process performed after the determination process is performed. In the sequential process, the matching unit 160 uses an output position information determined in a previous determination process as the recent position. Details of the determination process and the output position information are described later.

The position IP1 used as the initial matching position in the point cloud matching process MC1 is a position based on the provisional position PP. In this embodiment, the provisional position PP is used as the position IP1. The position IP2 used as the initial matching position in the point cloud matching process MC2 is a position offset from the provisional position PP. In this embodiment, the position IP2 is a position offset forward by a predetermined distance d1a from the provisional position PP. The position IP3, used as the initial matching position in the point cloud matching process MC3, is a position shifted from the provisional position PP. In this embodiment, the position IP3 is a position shifted backward by a predetermined distance d1b from the provisional position PP. That is, in this embodiment, the position based on the provisional position PP is used as the first position. As the second position, a shifted position displaced from the provisional position PP is used. In this embodiment, the shifted position is a position displaced from the provisional position PP in the forward or backward direction d1. As the first position, a position displaced from the provisional position PP may be used, not necessarily limited to the provisional position PP itself.

The estimation unit 170 shown in FIG. 1 estimates the vehicle position. The estimation unit 170 includes a first estimation unit 171, a second estimation unit 172, and a third estimation unit 173.

The first estimation unit 171 performs a matching estimation process when the matching difference information satisfies a predetermined first condition. In this embodiment, the first condition includes a fourth condition that the matching difference information is less than a predetermined threshold value. The matching estimation process is a process for estimating the vehicle position using matching result information. The vehicle position estimated by performing the matching estimation process is also referred to as the first estimated position.

In the matching estimation process, at least one matched position from the matching result information may be used, for example. In the estimation process, statistical values for each matched position may be used, for example, or any one matched position may be used. In the estimation process, at least one coordinate value from the matching result information may be used, for example. In this case, for example, the statistical values of each coordinate value on the same coordinate axis may be used, or any one coordinate value among the coordinate values on the same coordinate axis may be used. In the matching estimation process of this embodiment, the X-coordinate value and Y-coordinate value of the matched position obtained by performing the point cloud matching process, which is performed at a later timing, are used. That is, in the matching estimation process, the X-coordinate value and Y-coordinate value obtained by performing the point cloud matching process MC3 are used.

In this embodiment, in a case that the matching difference information does not satisfy the first condition, the first estimation unit 171 invalidates the matching result information. “Invalidating the matching result information” means invalidating it without using it in the matching estimation process, i.e., skipping the matching estimation process that uses that matching result information, and invalidating it without outputting the estimation result obtained by the matching estimation process using that matching result information. In this embodiment, when a matching result information is invalidated, the matching estimation process using the invalidated matching result information is skipped. As described later, in this embodiment, when a matching result information is invalidated, new matching process using new environmental point cloud data EP is performed.

The second estimation unit 172 estimates a second estimated position using the position information sensor 210. More specifically, the second estimation unit 172 estimates the second estimated position by acquiring the latitude and longitude of the vehicle 50 using signals output from GPS satellites and received by the position information sensor 210.

The third estimation unit 173 estimates a vehicle position using imaging data output from the peripheral vicinity camera 220. In this embodiment, the third estimation unit 173 estimates the vehicle position by identifying matching locations by comparing the road surface patterns contained in the imaging data output from the peripheral vicinity camera 220 with map information pre-stored in the memory 120. “Road surface patterns” means patterns formed by road markings such as white lines, various signs, manholes, gutters, shoulders, etc. The map information stores these road surface patterns associated with positional information. In addition to road surface patterns, the map information also stores point cloud data indicating landmarks such as buildings and guardrails, associated with positional information. However, in locations with relatively featureless road surfaces, such as public roads, estimating the vehicle position by comparing these road surface patterns with the map information may be difficult. The vehicle position estimated by the third estimation unit 173 is also referred to as a third estimated position.

In another embodiments, the estimation unit 170 may be configured to estimate the vehicle position using detection results from, for example, a forward-facing camera, LiDAR, or peripheral cameras.

The position determination unit 185 performs the determination process. The determination process is a process for determining the output position information of the vehicle 50 based on the vehicle positions estimated by each unit of the estimation unit 170. The output position information is used for autonomous driving of the vehicle 50. The position determination unit 185 determines the output position information by selecting one estimated position from among the estimated positions estimated by each unit of the estimation unit 170, according to a predetermined sixth condition. The sixth condition may be, for example, that the estimated position which has a higher reliability is selected. Reliability may be represented, for example, as the estimation accuracy of the estimated position. In this case, higher estimation accuracy indicates higher reliability. The vehicle position estimation device 100 may output the output position information to, for example, each of the drive force ECU 300, the brake ECU 400, and the steering ECU 500. Each of the drive force ECU 300, brake ECU 400, and steering ECU 500 uses the output position information to realize the autonomous driving function of the vehicle 50. The position determination unit 185 can exchange data with each of the matching unit 160 and each unit of the estimation unit 170.

The determination process described above and a process for realizing the autonomous driving function using the output position information correspond to a subsequent process. The subsequent process utilizes the estimated vehicle position results.

The recording processing unit 190 performs a recording process to record the recorded point cloud data RP in the memory 120. During the recording process, the recording processing unit 190 uses the sensors 200 to record the recorded point cloud data RP. More specifically, during the recording process, the recording processing unit 190 acquires point cloud data similar to the environmental point cloud data EP using sensors including the distance sensor 201 and acquires position information of the vehicle 50 using the position information sensor 210. The recording processing unit 190 then associates the acquired point cloud data with the position information, and records the point cloud data associated with the position information as the recorded point cloud data RP into the memory 120.The recording process is initiated, for example, when a control such as a switch provided on the vehicle 50 is operated by the driver of the vehicle 50. Similarly, the recording process is terminated, for example, when the control is operated by the driver. The control for initiating the recording process and the control for terminating the recording process may be different from each other or may be the same.

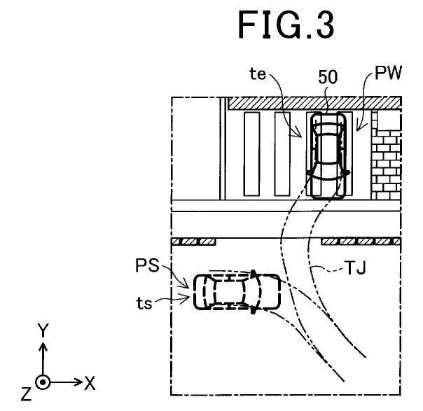

More specifically, as shown in FIG. 3, the driver may cause the recording processing unit 190 to start performing the recording process by operating the control at a position PS, for example, near the desired parking space PW. Subsequently, while the recording process is being performed, the driver manually operates the vehicle 50 to park it in the parking space PW. After parking is complete, the driver operates the control to instruct the recording processing unit 190 to terminate the recording process. As a result, point cloud data and position information are acquired for the period from the recording start timing ts to the recording end timing te, i.e., the period during which the vehicle 50 moves along trajectory TJ from the position PS to the parking space PW. The acquired point cloud data and position information are then recorded in association with each other, thereby recording the recorded point cloud data RP. This enables the recording processing unit 190 to record the recorded point cloud data RP as a point cloud map containing point cloud data representing the environment near the trajectory TJ.

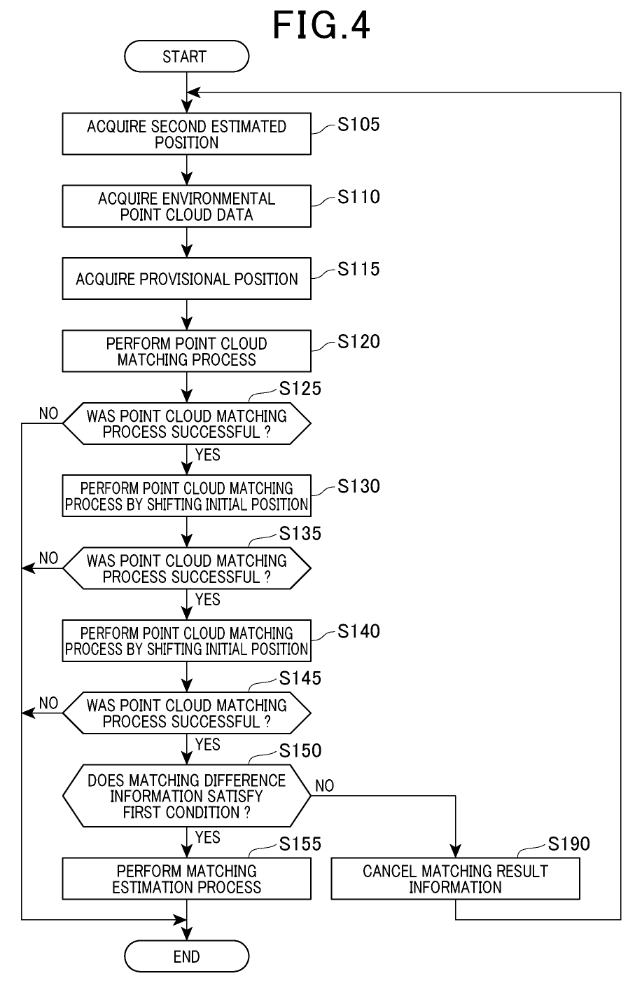

The vehicle position estimation process shown in FIG. 4 may be initiated by the processor 110, for example, when a predetermined operation is performed on the vehicle 50 by the driver and the vehicle 50 is located within a predetermined area. In this embodiment, the predetermined area is a vicinity area of the recording location where the recording process was performed. The predetermined area as the vicinity area may include the recording location itself. It may be determined whether the vehicle 50 is located within the predetermined area, for example, using the position information sensor 210. In this embodiment, the vehicle position estimation process is performed while the vehicle 50 is travelling. However, during any period while the vehicle position estimation process is being performed, the vehicle 50 may, for example, temporarily stop. The driving of the vehicle 50 may be realized by an autonomous driving function or by manual driving by the driver.

In step S105 of FIG. 4, the second estimation unit 172 estimates the second estimated position of the vehicle 50 using the position information sensor 210. In step S110, the point cloud acquisition unit 150 acquires the environmental point cloud data EP using the ranging sensor 201. In step S115, the matching unit 160 acquires the provisional position PP based on the second estimated position acquired in step S105. In step S120, the matching unit 160 performs the point cloud matching process MC1. More specifically, the matching unit 160 matches the environmental point cloud data EP and the recorded point cloud data RP acquired in step S110, using the provisional position PP acquired in step S115 as the initial matching position.

In step S125, the matching unit 160 determines whether the point cloud matching process MC1 in step S120 was successful. The matching unit 160 determines that the point cloud matching process MC1 is successful in a case that a residual between the environmental point cloud data EP the and recorded point cloud data RP at the convergence time of the point cloud matching process MC1 is less than or equal to a predetermined threshold residual, and determines that the point cloud matching process is unsuccessful in a case that the residual is greater than the threshold residual. The residuals in point cloud matching process tends to become relatively large, for example, when disturbances in the surrounding environment of the vehicle 50 affect the environmental point cloud data EP.

In a case that the point cloud matching process MC1 is determined to be unsuccessful in step S125, the matching unit 160 terminates the vehicle position estimation process. In a case that the point cloud matching process MC1 is determined to be unsuccessful in step S125, for example, the position determination unit 185 may perform the determination process and determine the vehicle position estimated by the second estimation unit 172 and/ or the third estimation unit 173 to be the output position information of the vehicle 50. In a case that the point cloud matching process MC1 is determined to be unsuccessful in step S125, the vehicle position estimation process may be restarted without performing the determination process. Here, when the point cloud matching process was unsuccessful due to the environmental point cloud data affected by disturbances, in the restarted vehicle position estimation process, for example, the environmental point cloud data may improve due to the disturbance leaving or travelling of the vehicle 50, and the point cloud matching process may become successful.

In a case that the point cloud matching process MC1 is determined to be successful in step S125, in step S130, the matching unit 160 performs the point cloud matching process MC2 by shifting the initial position from the initial position used in the point cloud matching process MC1. More specifically, as shown in FIG. 2, the matching unit 160 uses the position IP2, shifted forward by the predetermined distance d1a from the provisional position PP, as the initial position to match the environmental point cloud data EP and the recorded point cloud data RP obtained in step S110. In step S135, the matching unit 160 determines whether the point cloud matching process MC2 obtained by performing the process of step S130 is successful, similarly to step S125. In a case that the point cloud matching process MC2 is determined to be unsuccessful in step S135, the matching unit 160 terminates the vehicle position estimation process, as in the case of step S125.

In a case that the point cloud matching process MC2 is determined to be successful in step S135, in step S140, the matching unit 160 performs the point cloud matching process MC3 by shifting the initial position from the initial positions of the point cloud matching process MC1 and the point cloud matching process MC2. More specifically, as shown in FIG. 2, the matching unit 160 uses the position IP3, shifted backward by the predetermined distance d1b from the provisional position PP, as the initial position, and matches the environmental point cloud data EP and the recorded point cloud data RP obtained in step S110. In step S145, the matching unit 160 determines whether the point cloud matching process MC3 obtained by performing the process of step S140 is successful, similar to step S125. In a case that the point cloud matching process MC3 is determined to be unsuccessful in step S145, the matching unit 160 terminates the vehicle position estimation process, as in the case of step S125.

In step S150, the matching unit 160 compares the matched positions MP1, MP2, and MP3 of the point cloud matching process MC1, MC2, and MC3, respectively, and determines whether the matching difference information satisfies the first condition.

Here, for example, when each environmental point cloud data used in the matching process contains the relatively large number of features such as edges, even when different initial matching positions are used in each point cloud matching process, the environmental point cloud data EP and the recorded point cloud data RP tend to match at similar positions within each point cloud matching process. As a result, the variation between matched positions is suppressed, increasing the likelihood that the first condition is satisfied in step S150. On the other hand, when the vehicle position estimation is performed while the vehicle 50 is traveling on relatively featureless straight roads, features of the environmental point cloud data EP become relatively sparse, and depending on the differences in the initial matching positions within each point cloud matching process, the results for each point cloud matching process tend to converge to distinct local optima. Consequently, the matched positions tend to vary, increasing the likelihood that the first condition will not be satisfied in step S150. Even if the results of each point cloud matching process fall into different local optima as described above, the residuals for each point cloud matching process are likely to be relatively small, making it difficult to evaluate the degree of variation between matched positions using these residuals. In contrast, this embodiment can effectively evaluate the degree of variation between the matched positions using a matching difference information. As a result, it is possible to evaluate whether the vehicle 50 is in a situation where inappropriate matching result information may occur due to insufficient surrounding environment features, based on the matching difference information.

In a case that the first condition is satisfied in step S150, in step S155, the first estimation unit 171 performs the matching estimation process to estimate the first estimated position using the matching result information. Then the first estimation unit 171 outputs this estimated first estimated position to the position determination unit 185. The position determination unit 185 performs the determination process, taking into account the output first estimated position.

In a case that the first condition is not satisfied in step S150, in step S190, the first estimation unit 171 invalidates the matching result information and returns process to step S105 without performing the estimation process. The subsequent repeat steps S105 and S110 are performed after the vehicle 50 has moved due to its travel. In the repeat steps S105 and S110, the second estimated position and the environmental point cloud data are newly acquired. Therefore, in the subsequent step S110 after step S150, it is highly likely that new environmental point cloud data, different from the environmental point cloud data EP used in the matching process where the first condition was not satisfied, will be acquired. At this time, when the vehicle 50 has moved to a location with relatively many features, newly acquired environmental point cloud data may contain relatively many features. As a result, in the subsequent matching process after step S150, the matching difference information may satisfy the first condition.

According to the vehicle position estimation device 100 of the present embodiment described above, when the matching difference information does not satisfy first condition, the matching result information is invalidated. Therefore, it is possible to suppress a decrease in the estimation accuracy of the vehicle position caused by an inappropriate matching result information, and to suppress the influence of an inappropriate matching result information on subsequent process that uses the estimated vehicle position result.

In this embodiment, when the matching difference information does not satisfy the first condition, the matching result information is invalidated. As a result, new environmental point cloud data is acquired in the vehicle 50 that has travelled, and the matching process is performed using newly acquired environmental point cloud data. This increases the likelihood that the vehicle position will be estimated using an appropriate matching result information.

In this embodiment, the second position is a position displaced from the first position in the longitudinal direction d1 of the vehicle 50. Whether the vehicle 50 is in a situation where an inappropriate matching result information may occur is more appropriately reflected in the matching difference information. This further reduces the possibility that the estimation accuracy of the vehicle position will decrease due to an inappropriate matching result information.

### B. Second Embodiment:

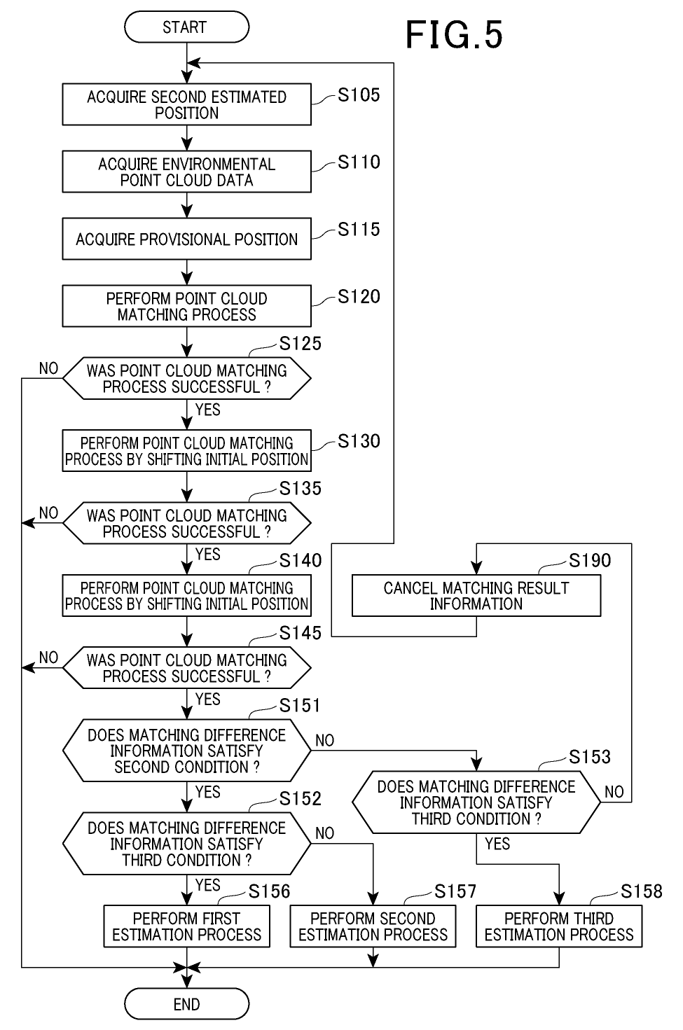

As shown in FIG. 5, in a vehicle position estimation process of a second embodiment, unlike the first embodiment, different processes are performed depending on whether the matching difference information satisfies a second condition and whether the matching difference information satisfies a third condition. In FIG. 5, steps identical to those in FIG. 4 are labeled with the same step number. For the configuration of the driving support system 10 and the vehicle position estimation device 100 in the second embodiment, aspects not specifically described are the same as in the first embodiment.

The first condition in this embodiment includes the second condition and the third condition. The second condition is a condition about the X-coordinate value difference. The X-coordinate value difference is a difference between the first X-coordinate value and the second X-coordinate value. More specifically, in this embodiment, the X coordinate value difference is a distance between the first X coordinate value and the second X coordinate value. The Y coordinate value difference is a difference between the first Y coordinate value and the second Y coordinate value. More specifically, in this embodiment, the Y coordinate value difference is a distance between the first Y coordinate value and the second Y coordinate value. In this embodiment, the second condition further includes the condition that the X coordinate value difference is less than or equal to a predetermined first reference value. The third condition is a condition related to the Y coordinate value difference. More specifically, in this embodiment, the third condition includes the condition that the Y-coordinate value difference is less than or equal to a predetermined second reference value. In this embodiment, the first condition is satisfied when at least one of the second condition and the third condition is satisfied.

After step S145, in step S151, the matching unit 160 determines whether the matching difference information satisfies the second condition. In a case that the second condition is satisfied in step S151, in step S152, the matching unit 160 determines whether the matching difference information satisfies the third condition.

In a case that the third condition is satisfied in step S152, i.e., both the second condition and the third condition are satisfied, in step S156, the first estimation unit 171 performs the first estimation process. The first estimation process is a process for estimating the vehicle position using the X coordinate value information and the Y coordinate value information. The X-coordinate value information includes at least one of the first X-coordinate value and the second X-coordinate value. The Y-coordinate value information includes at least one of the first Y-coordinate value and the second Y-coordinate value. That is, the first estimation process is a process for estimating the vehicle position by considering both the X-coordinate value and the Y-coordinate value as the matching result information. The first estimation process corresponds to the estimation process performed in the first embodiment.

In a case that the third condition is not satisfied in step S152, i.e., in a case that the second condition is satisfied but the third condition is not satisfied, then in step S157, the first estimation unit 171 performs the second estimation process. The second estimation process is a process for estimating the vehicle X coordinate value using the X coordinate value information and invalidating the Y coordinate value information. The vehicle X coordinate value is the coordinate value on the X-axis of the vehicle position. “Invalidating the Y coordinate value information” means both invalidating the Y coordinate value information without using it in the second estimation process and invalidating the vehicle Y coordinate value estimated using the Y coordinate value information. Subsequently, the first estimation unit 171 outputs the estimated vehicle X coordinate value to the position determination unit 185.

In a case that the second condition is not satisfied in step S151, in step S153, similar to step S152, the matching unit 160 determines whether the matching difference information satisfies the third condition.

In a case that the third condition is satisfied in step S153, i.e., the third condition is satisfied while the second condition is not satisfied, in step S158, the first estimation unit 171 performs the third estimation process. The third estimation process is a process for estimating the vehicle Y coordinate value using the Y coordinate value information and without using the X coordinate value information. The vehicle Y coordinate value is the coordinate value on the Y-axis of the vehicle position. Subsequently, the first estimation unit 171 outputs the estimated vehicle Y coordinate value to the position determination unit 185.

In a case that the third condition is not satisfied in step S153, i.e., if both the second condition and the third condition are not satisfied, then in step S190, the first estimation unit 171 invalidates the matching result information, as in step S190 of FIG. 4, and returns the process to step S105.

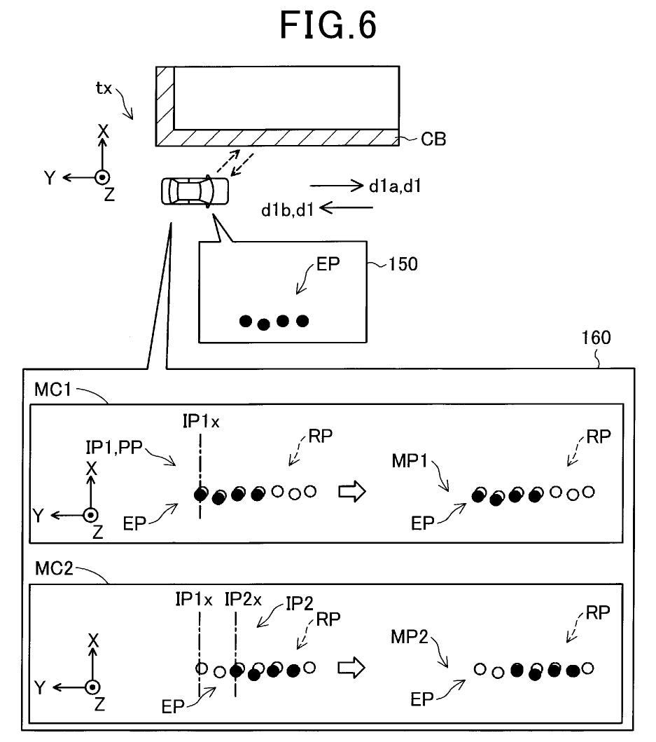

For example, in FIG. 6, the vehicle 50 is traveling along a single road extending in the Y direction. In this case, similar point cloud arrangements tend to repeat in the Y direction within the recorded point cloud data RP. Consequently, depending on the differences in the initial matching positions for each point cloud matching process, the Y-coordinate values at the matched positions tend to vary between the results for each point cloud matching process. On the other hand, in the example of FIG. 6, since similar point cloud arrangements are not repeated in the X direction in the recorded point cloud data PRP, the X coordinate values at the matched positions tend to be relatively less variable between the results of each point cloud matching process. That is, in the example of FIG. 6, the probability that the Y coordinate values at the matched positions are inappropriate is high, while the probability that the X coordinate values at the matched positions are appropriate is high. In this embodiment, when such a case occurs, performing the second estimation process enables estimation of the vehicle X coordinate value using the X coordinate value information with a high probability of being appropriate, while avoiding the use of the Y coordinate value information with a high probability of being inappropriate.

According to the second embodiment described above, when the probability that both the X-coordinate value information and the Y-coordinate value information are appropriate is high, the vehicle position is estimated accurately using both the X-coordinate value information and the Y-coordinate value information. When the probability that the Y-coordinate value information is inappropriate is high, the influence of the inappropriate Y-coordinate value information on subsequent process is suppressed. When the probability that the X-coordinate value information is inappropriate is high, the influence of the inappropriate X-coordinate value information on subsequent process is suppressed. More specifically, when both the second condition and the third condition are satisfied, the first estimation process is performed. As a result, the vehicle position is accurately estimated using both the X-coordinate value information and the Y-coordinate value information, which are highly likely to be appropriate. On the other hand, when the second condition is satisfied but the third condition is not satisfied, the second estimation process is performed. As a result, the vehicle X coordinate value is accurately estimated using only the X coordinate value information with a high probability of being appropriate, while also suppressing the decrease in estimation accuracy caused by the inclusion of the Y coordinate value information with a high probability of being inappropriate in the estimation result. When the third condition is satisfied but the second condition is not satisfied, the third estimation process is performed. This enables accurate estimation of the vehicle Y-coordinate value using only the Y-coordinate value information with a high probability of being appropriate, while also suppressing the decrease in estimation accuracy caused by reflecting the X-coordinate value information with a high probability of being inappropriate in the estimation result.

### C. Third Embodiment:

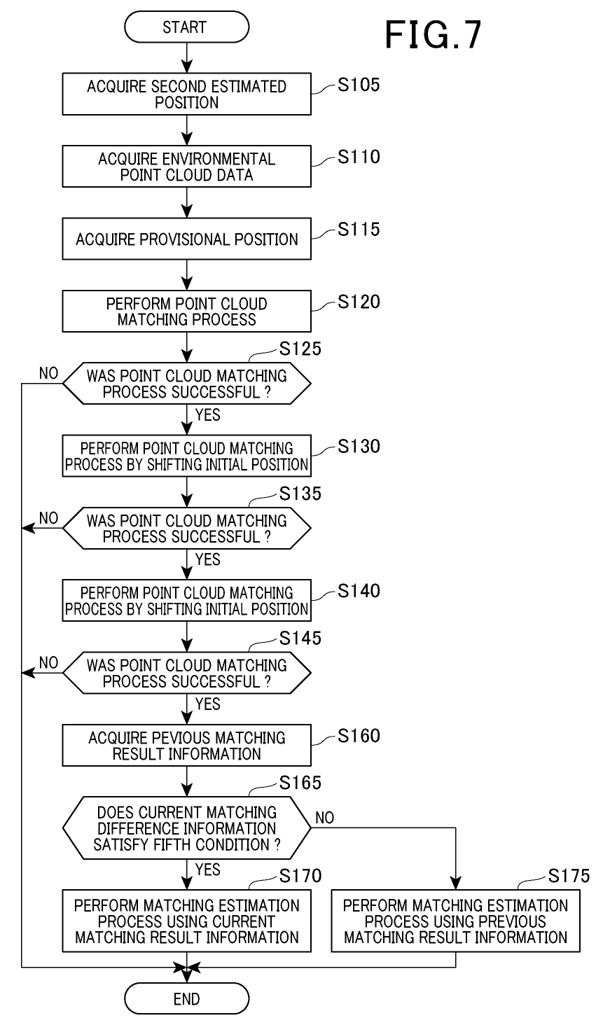

As shown in FIG. 7, in the vehicle position estimation process of a third embodiment, depending on whether the current matching difference information satisfies a fifth condition, either one of the current matching result information or the previous matching result information is used in the estimation process. In FIG. 7, steps identical to those in FIG. 4 are labeled with the same step numbers. For aspects of the configuration of the driving support system 10 and the vehicle position estimation device 100 in the third embodiment that are not specifically described, they are the same as in the first embodiment.

The fifth condition is that the current matching difference information is less than or equal to the previous matching difference information. The current matching difference information is the matching difference information obtained in the current matching process. The previous matching difference information is the matching difference information obtained in the previous matching process. The previous matching difference information is the difference between the previous first matched position and the previous second matched position. The current matching result information is the matching result information of the current matching process. The previous matching result information is the matching result information of the previous matching process. The matching result information includes the previous first matched position and the previous second matched position.

In this embodiment, after step S145, in step S160, the matching unit 160 acquires the previous matching result information.

In step S165, the matching unit 160 determines whether the current matching difference information satisfies the first condition. In this embodiment, the first condition includes the fifth condition but does not include the fourth condition. Therefore, in step S165, the matching unit 160 determines whether the current difference satisfies the fifth condition.

In a case that the fifth condition is satisfied in step S165, in step S170, the first estimation unit 171 estimates the vehicle position using the current matching difference information. In a case that the fifth condition is not satisfied in step S165, in step S175, the first estimation unit 171 invalidates the current matching result information and estimates the vehicle position using the previous matching result information.

According to the third embodiment described above, when the current matching difference information does not satisfy the fifth condition, the current matching result information is invalidated, and the vehicle position is estimated using the previous matching result information, which is highly likely to be more appropriate than the current matching result information. As a result, the possibility of accurately estimating the vehicle position is further enhanced.

### D. Fourth Embodiment:

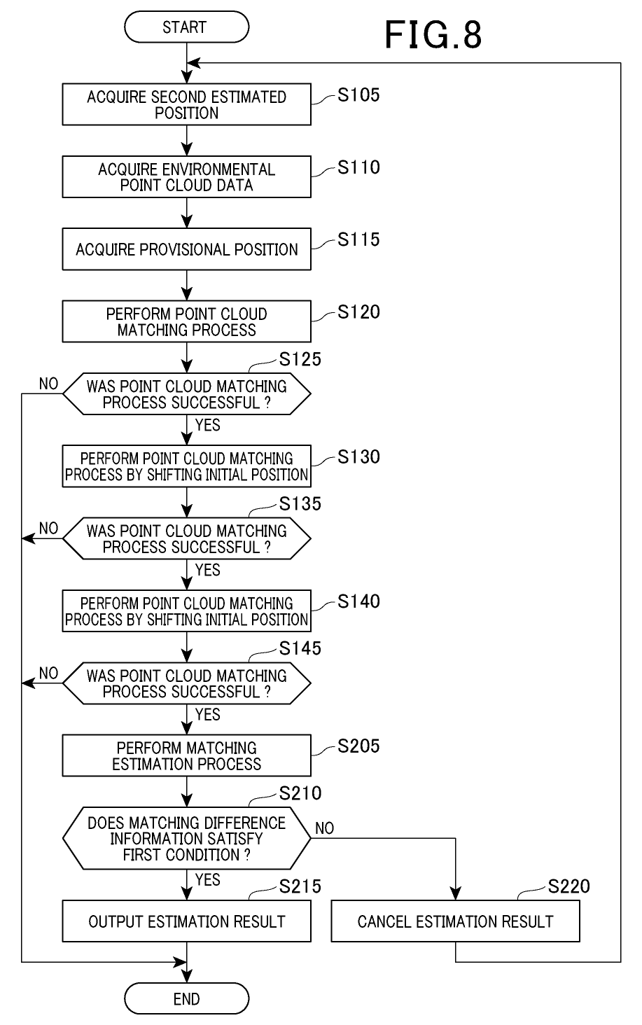

As shown in FIG. 8, in the vehicle position estimation process of the fourth embodiment, when the matching difference information does not satisfy the first condition, the estimated vehicle position result obtained by performing the estimation process is invalidated, thereby invalidating the matching result information. In FIG. 8, steps identical to those in FIG. 4 are labeled with the same step numbers. For aspects of the configuration of the driving support system 10 and the vehicle position estimation device 100 in the fourth embodiment that are not specifically described, they are the same as in the first embodiment.

After step S145, in step S205, the first estimation unit 171 performs the estimation process. That is, in this embodiment, the first estimation unit 171 performs the estimation process using the matching result information regardless of whether the matching difference information satisfies the first condition.

In step S210, the matching unit 160 determines whether the matching difference information satisfies the first condition. In a case that the first condition is satisfied in step S210, in step S215, the first estimation unit 171 outputs the estimated vehicle position result obtained by performing the estimation process in step S205 to the position determination unit 185. In a case that the first condition is not satisfied in step S210, in step S220, the first estimation unit 171 invalidates the estimation result obtained by performing the process of step S205 without outputting it.

The fourth embodiment described above also suppresses the influence of inappropriate matching result information on subsequent process that uses the estimated vehicle position result. More specifically, in this embodiment, since the estimated result obtained by performing the estimation process is invalidated in a case that the matching difference information does not satisfy the first condition, it suppresses the output of inappropriate estimated results caused by inappropriate matching result information to the position determination unit 185.

In the fourth embodiment, the matching difference information may be defined as the difference between vehicle positions as estimation results from each estimation process using each matching result information.

### E. Fifth Embodiment:

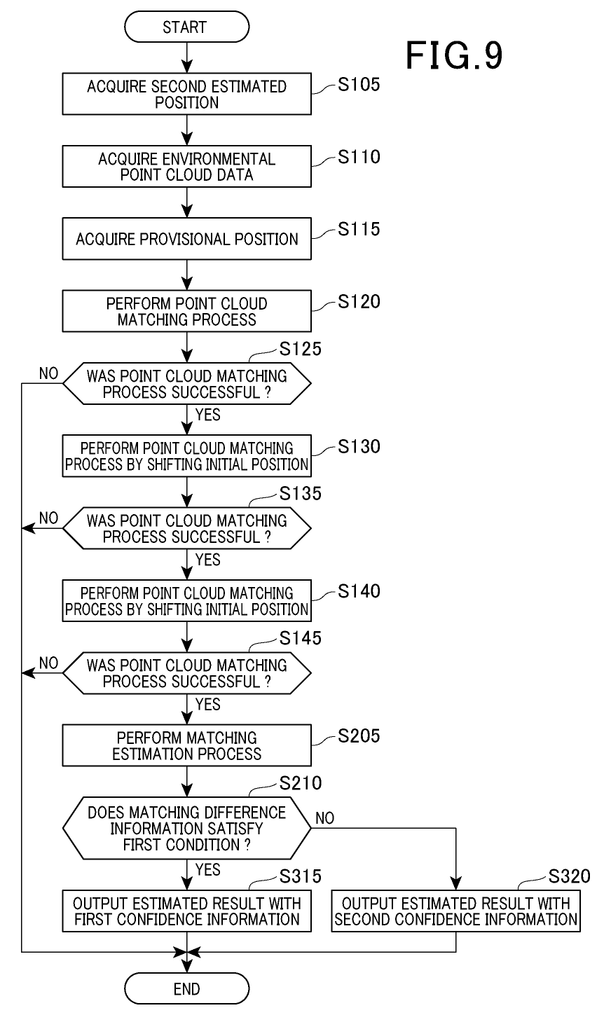

As shown in FIG. 9, in the vehicle position estimation process of the fifth embodiment, in a case that the matching difference information satisfies the first condition, the first estimation unit 171 outputs the estimated result obtained by performing the estimation process along with a first confidence information to the position determination unit 185. On the other hand, in a case that the matching difference information does not satisfy the first condition, the first estimation unit 171 outputs the estimated result along with second confidence information. Each of the first confidence information and the second confidence information represent a reliability of the estimation result. The second confidence information indicates lower reliability than the first confidence information. That is, the first estimation unit 171 reduces the reliability of the estimation result when the matching difference information does not satisfy the first condition, compared to when the matching difference information satisfies the first condition. In FIG. 9, the same step numbers are used for steps identical to those in FIGS. 4 and 8. For aspects of the configuration of the driving support system 10 and the vehicle position estimation device 100 in the fifth embodiment that are not specifically described, they are the same as in the first embodiment.

As described above, the reliability of the estimation result may be expressed as the estimation accuracy of the estimation result. In this case, the second reliability information represents an estimation accuracy lower than the estimation accuracy represented by the first reliability information. At least one of the reliabilities represented by the first reliability information and the reliability represented by the second reliability information respectively may be variable, for example, in accordance with the matching difference information. In this way, the position determination unit 185 can determine the output position information more appropriately compared to when both reliabilities represented by the first reliability information and the second reliability information respectively are a fixed value.

In this embodiment, as in the fourth embodiment, after step S145, in step S205, the first estimation unit 171 performs the estimation process without invalidating the matching result information, regardless of whether the matching difference information satisfies the first condition.

Subsequently, in step S210, the matching unit 160 determines whether the matching difference information satisfies the first condition. In a case that the first condition is satisfied in step S210, in step S315, the first estimation unit 171 outputs the estimated vehicle position result obtained by performing the estimation process in step S205, along with the first confidence information, to the position determination unit 185. In a case that the first condition is not satisfied in step S210, in step S320, the first estimation unit 171 outputs the second confidence information to the position determination unit 185 along with the estimation result obtained by performing the estimation process in step S205.The position determination unit 185 determines the output position information more appropriately by taking into account the first confidence information output in step S315 and the second confidence information output in step S320. For example, in a case that the confidence of the third estimated position is higher than the confidence represented by the second confidence information, the position determination unit 185 determines the output position information using the third estimated position.

The fifth embodiment described above also suppresses the influence of an inappropriate matching result information on subsequent process that uses the estimated vehicle position result. More specifically, in this embodiment, when the matching difference information does not satisfy the first condition, the reliability of the estimation result is reduced. Therefore, in a subsequent process, it is possible to determine the process content by taking the reliability of the estimation result into account. For example, subsequent process can determine whether to use the estimation result by considering its reliability.

### F. Sixth Embodiment:

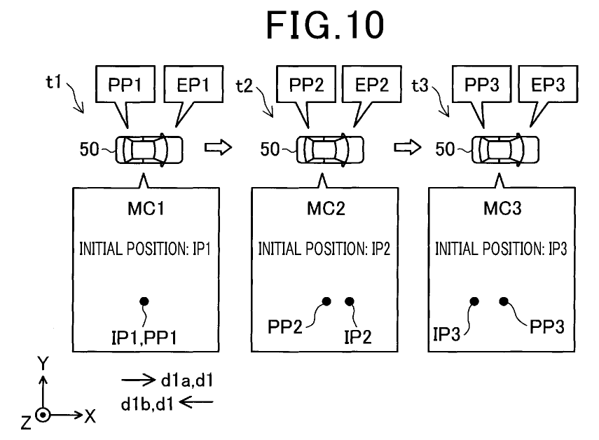

As shown in FIG. 10, in this embodiment, the point cloud acquisition unit 150 acquires multiple environmental point cloud data including environmental point cloud data EP1, environmental point cloud data EP2, and environmental point cloud data EP3. The environmental point cloud data EP1, the environmental point cloud data EP2, and the environmental point cloud data EP3 are point cloud data represents the surrounding environment of the vehicle 50 at timings t1, t2, and t3, respectively. Timing t2 is later than timing t1. Timing t3 is later than timing t2. In this embodiment, the vehicle 50 travels during the period from timing t1 to timing t3. Regarding the configuration of the driving support system 10 and the vehicle position estimation device 100 in the sixth embodiment, aspects not specifically described are the same as in the first embodiment.

When the environmental point cloud data EP1 is defined as the first environmental point cloud data, each of the environmental point cloud data EP2 and the environmental point cloud data EP3 is defined as the second environmental point cloud data. The first environmental point cloud data represents the surrounding environment of the vehicle 50 at the first timing. The second environmental point cloud data represents the surrounding environment of vehicle 50 at a second timing. The second timing is later than the first timing. Similarly, for example, when the environmental point cloud data EP2 is defined as the first environmental point cloud data, the environmental point cloud data EP3 is defined as the second environmental point cloud data. During the period between the first timing and the second timing, the vehicle 50 travels by driving.

In this embodiment, the first position is a location based on a first provisional position described later, and the second position is the shift position. However, the shift position in this embodiment is a position offset in the forward or backward direction d1 from a second provisional position described later.

In this embodiment, the environmental point cloud data EP1, EP2, and EP3 are used as the environmental point cloud data in the point cloud matching process MC1, MC2, and MC3, respectively. Consequently, in this embodiment, matching is performed between the first environmental point cloud data and the recorded point cloud data RP in the first point cloud matching process, and matching is performed between the second environmental point cloud data and the recorded point cloud data RP in the second point cloud matching process.

In this embodiment, the matching unit 160 acquires provisional positions PP1, PP2, and PP3 as provisional positions. The provisional positions PP1, PP2, and PP3 are the provisional positions at timings t1, t2, and t3, respectively. The provisional positions PP1, PP2, and PP3 are acquired in the same manner as the provisional position PP in the first embodiment.

When the provisional position PP1 is defined as the first provisional position, each of the provisional positions PP2 and PP3 is defined as the second provisional position. The first provisional position is a provisional position at a first timing. The second provisional position is a provisional position at a second timing.

The position IP1 used as the initial matching position in the point cloud matching process MC1 is a position based on the provisional position PP1. More specifically, in this embodiment, the provisional position PP1 is used as the position IP1. The position IP2 used as the initial matching position in the point cloud matching process MC2 is a position offset from the provisional position PP2. More specifically, in this embodiment, the position IP2 is a position offset forward by a predetermined distance from the provisional position PP2. The position IP3, used as the initial matching position in point cloud matching process MC3, is a position shifted from the provisional position PP3. More specifically, in this embodiment, the position IP3 is a position shifted backward by a predetermined distance from the provisional position PP3. That is, in this embodiment, a position based on the first provisional position is used as the first position and a position based on the second provisional position is used as the second position. At least one of the first position and the second position is a shifted position displaced from the respective provisional position. That is, the first position as a shifted position is a position displaced from the first provisional position, and/or the second position as a shifted position is a position displaced from the second provisional position.

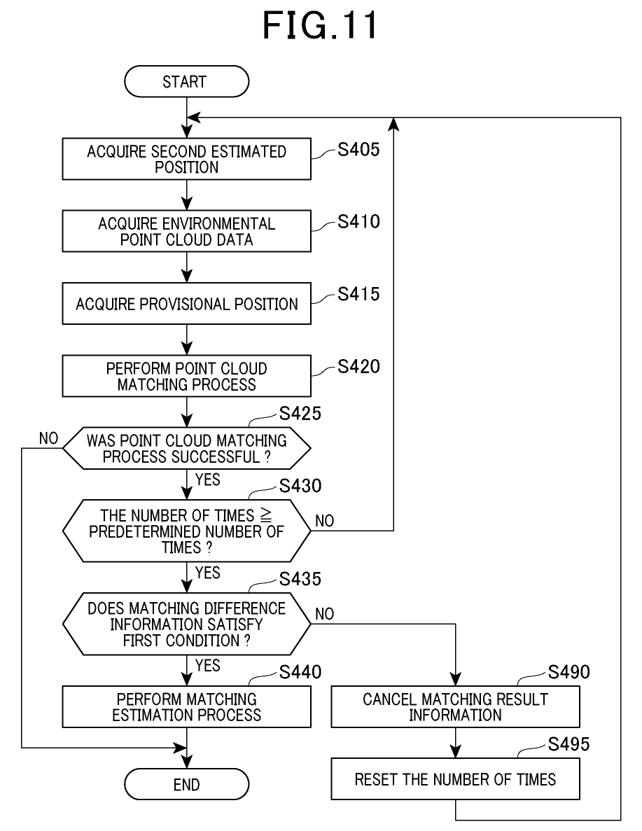

In this embodiment, the vehicle position estimation process shown in FIG. 11 is performed. Steps S405 to S425 in FIG. 4 are the same as steps S105 to S125. In step S430, the matching unit 160 determines whether the number of times the point cloud matching process has been performed is equal to or greater than a predetermined number of times. In this embodiment, the predetermined number is three. In a case that the number of times is less than the predetermined number of times in step S430, the matching unit 160 returns the process to step S405. That is, steps S405 to S430 shown in FIG. 11 are performed multiple times until the number of times of performance of the point cloud matching process reaches or exceeds the predetermined number of times.

In step S410 performed during the first, second, and third times, the second estimated position at the timing t1, t2, and t3 shown in FIG. 2 is acquired, respectively. In step S410 performed during the first, second, and third times, the environmental point cloud data EP1, EP2, and EP3 shown in FIG. 2 are acquired, respectively. In step S415 performed during the first, second, and third times, the provisional positions PP1, PP2, and PP3 shown in FIG. 2 are acquired, respectively. In step S420 performed during the first, second, and third times, the point cloud matching process MC1, MC2, and MC3 shown in FIG. 2 are processed, respectively. In step S425 performed during the first, second, and third times, it is determined whether the point cloud matching process MC1, MC2, and MC3 was successful.

In a case that the number of times is greater than or equal to a predetermined number in step S430, i.e., the point cloud matching process have been performed three times, then in step S435, the matching unit 160 compares the matched positions obtained by performing the point cloud matching process in each step S120, similar to step S150 in FIG. 4, and determines whether the matching difference information satisfies the first condition. In this embodiment, for example, the matched positions of point cloud matching process MC1, MC2, and MC3 may be corrected according to the amount of travel of the vehicle 50 between each timing t1, t2, and t3, and then compared.

In a case that the first condition is satisfied in step S435, in step S440, the first estimation unit 171 performs the estimation process to estimate the first estimated position using matching result information. In step S440 of this embodiment, the first estimation unit 171 estimates the first estimated position using the matched positions from the point cloud matching process MC3, which was performed at the latest timing among the three point cloud matching processes. This allows the first estimated position to be estimated more accurately using the latest matched positions. The estimated first estimated position is then output to the position determination unit 185.

In a case that the first condition is not satisfied in step S435, in step S490, the first estimation unit 171 invalidates the matching result information and skips the estimation process. Then, in step S495, the first estimation unit 171 resets the performance count and returns the process to step S405. Subsequent steps S405 and S410 after step S495 are performed while the vehicle 50 has travels, and new second estimated position and the environmental point cloud data are acquired. Therefore, in the subsequent step S410 after step S495, it is highly likely that new environmental point cloud data, different from the respective environmental point cloud data EP1, EP2, EP3 used for the matching process where first condition was not satisfied, will be acquired.

According to the sixth embodiment described above, while the vehicle 50 is travelling, the first matching process is performed using the first environmental point cloud data corresponding to the first timing, and the second matching process is performed using the second environmental point cloud data corresponding to the second timing. Therefore, while the vehicle 50 is travelling, the following sequence of process is realized in real time. Specifically, while sequentially acquiring the environmental point cloud data, the matching process is performed using each of the sequentially acquired environmental point cloud data. In a case that the first condition is satisfied, the matching result information is used to appropriately estimate the vehicle position. In a case that the first condition is not satisfied, process is performed to suppress the impact of the subsequent process caused by inappropriate matching result information. In particular, since at least one of the first position and the second position is the shift position in this embodiment, the first position and the second position is effectively offset while taking into account the amount of movement of the vehicle 50 between the first timing and the second timing, enabling matching process to be performed more effectively.

In the sixth embodiment, as in the second embodiment, different process may be performed depending on whether the second condition is satisfied, and whether the third condition is satisfied. In the sixth embodiment, as in the third embodiment, either the current matching result information or the previous matching result information may be used depending on whether the fifth condition is satisfied. In the sixth embodiment, as in the fourth and fifth embodiments, invalidation of the estimation result or reduction of the estimation result's reliability may be performed when the first condition is not satisfied. That is, the configuration of sequentially acquiring environmental point cloud data while sequentially performing matching process using each sequentially acquired environmental point cloud data, as in the sixth embodiment, may be applied to any of the first through fifth embodiments described above.

### G. Other Embodiments:

(G-1) In each of the above embodiments, when the matching difference information does not satisfy the first condition, it is sufficient to perform at least one of (a) invalidating the matching result information and (b) reducing the reliability of the estimation result compared to when the first condition is satisfied. For example, (b) and (a) may be selectively performed depending on the degree of the matching difference information. For example, (b) may be performed in a case that the matching difference information is the first difference, and (a) may be performed in a case that the matching difference information is a second difference, which is smaller than the first difference. This allows immediate invalidation of the matching result information without requiring the position determination unit 185 to determine whether to set the first estimated position as the output position information when the matching difference information is larger, thereby reducing the process load on the vehicle position estimation device 100.

(G-2) In the second embodiment described above, the second estimation process is performed when the second condition is satisfied and third condition is not satisfied, but it is not limited to this configuration. For example, when the second condition is satisfied and the third condition is not satisfied, the first estimation unit 171 may perform the first estimation process and lower the confidence level of the estimated vehicle Y-coordinate value relative to the confidence level of the estimated vehicle X-coordinate position.

(G-3) In the above embodiments, the second position is a position offset from the first position in the longitudinal direction d1, but it is not limited to this configuration. For example, the second position may be a position offset from the first position in the width direction of the vehicle 50.

### H. Other Forms:

The present disclosure is not limited to the above embodiments and may be realized in various configurations within the scope of the spirit of the invention. For example, the technical features in the embodiments may be appropriately substituted or combined to solve some or all the above problems or to achieve some or all of the above effects. If a technical feature is not described herein as essential, it may be appropriately omitted.

The control unit and its method described in this disclosure may be implemented by a dedicated computer provided by configuring a processor and memory programmed to execute one or more functions embodied by a computer program. Alternatively, the control unit and its method described in this disclosure may be implemented by a dedicated computer provided by configuring a processor using one or more dedicated hardware logic circuits. Alternatively, the control unit and method described herein may be implemented by one or more dedicated computers configured with a combination of a processor and memory programmed to execute one or more functions, and one or more processors configured by hardware logic circuits. The computer program may be stored on a computer-readable, non-transitory tangible medium as instructions executable by a computer.

### Form 1

A vehicle position estimation device (100) comprises: a point cloud acquisition unit (150) configured to acquire environmental point cloud data (EP) representing a surrounding environment of a vehicle (50) using sensors mounted to the vehicle, a matching unit (160) configured to perform a matching process between the acquired environmental point cloud data and recorded point cloud data (RP), and an estimation unit (170) configured to perform an estimation process to estimate a vehicle position that is a position of the vehicle based on a matching result information of the matching process. The matching unit is configured to perform, in the matching process, a first matching process using a first position as an initial position and a second matching process using a second position different from the first position as an initial position. The matching result information includes a first matched position that is a result of the first matching process and a second matched position that is a result of the second matching process. In a case that a matching difference information representing the difference between first matched position and second matched position does not satisfy a first condition, the estimation unit performs at least one of: (a) invalidating at least part of the matching result information; and (b) reducing the reliability of the estimated vehicle position obtained by the estimation process compared to in a case that the matching difference information satisfies the first condition.

### Form 2

In the vehicle position estimation device according to Form1, the matching difference information may be information of a distance between the first matched position and the second matched position.

### Form 3

In the vehicle position estimation device according to Forms 1 or 2, in a case that the matching difference information does not satisfy the first condition, the matching result information may be invalidated, and in a case that a different environmental point cloud data is newly acquired due to a movement of the vehicle, the matching process using newly acquired environmental point cloud data may be performed.

### Form 4

In the vehicle position estimation device according to any one of Forms 1 to 3, the first matched position may be represented by a first X coordinate value on the X-axis and a first Y coordinate value on the Y-axis perpendicular to the X-axis. The second matched position may be represented by a second X coordinate value on the X-axis and a second Y coordinate value on the Y-axis. The vehicle position may be represented by a vehicle X coordinate value on the X-axis and a vehicle Y coordinate value on the Y-axis. The matching difference information may include a difference between the first X coordinate value and a second X coordinate value; and a difference between the first Y coordinate value and the second Y coordinate value. The first condition may be a condition satisfied in a case that at least one of a second condition and a third condition, the second condition relating to the difference between the first X coordinate value and the second X coordinate value, and the third condition relating to the difference between the first Y coordinate value and the second Y coordinate value. The estimation unit may be configured to: in a case that both the second condition and the third condition are satisfied, perform a first estimation process as the estimation process, the first estimation process being a process to estimate the vehicle X coordinate value and the vehicle Y coordinate value based on a X coordinate value information and a Y coordinate value information, the X coordinate value information including at least one of the first X coordinate value and the second X coordinate value, and the Y coordinate value information including at least one of the first Y coordinate value and the second Y coordinate value, in a case that the second condition is satisfied and the third condition is not satisfied, perform at least one of: (c) a second estimation process that estimates the vehicle X coordinate value using the X coordinate value information and invalidating the Y coordinate value information, and (d) the first estimation process and reducing the reliability of the estimated vehicle Y coordinate value compared to the reliability of the estimated vehicle X coordinate value, and in a case that both the second condition and the third condition are not satisfied, perform at least one of: (a) invalidating at least part of the matching result information, and (b) reducing the reliability of the estimated vehicle position obtained by the estimation process compared to in a case that the matching difference information satisfies the first condition.

### Form 5

In the vehicle position estimation device according to any one of Forms 1 to 4, the matching unit may acquire previous matching result information. The first condition may be that the current matching difference information is less than or equal to the previous matching difference information. The estimation unit may, in a case that the current matching difference information does not satisfy the condition fifth condition, (a) invalidates the present matching result information and estimates the vehicle position using the previous matching result information in the estimation process.

### Form 6

In the vehicle position estimation device according to any one of Forms 1 to 5, the environmental point cloud data may include first environmental point cloud data representing the surrounding environment of a vehicle at a first timing, and second environmental point cloud data representing the surrounding environment of the vehicle at a second timing after the first timing. When the vehicle travels between the first timing and the second timing, the matching unit may: perform, the first matching process using the first environmental point cloud data and the second matching process using the second environmental point cloud data, acquire a first provisional position, that is a provisional position of the vehicle at the first timing, and a second provisional position, that is a provisional position at the second timing, and set a position based on the first provisional position to the first position and set a position based on the second provisional position to the second position. The first position may be a deviated position from the first provisional position and/or the second position may be a deviated position from the second provisional position.

### Form 7

In the vehicle position estimation device according to any one of Forms 1 to 6, the second position may be a position deviated from the first position in the longitudinal direction of the vehicle.

### Form 8

A vehicle position estimation method performed by a processor comprises: acquiring environmental point cloud data representing a surrounding environment of a vehicle using sensors mounted to the vehicle, performing a matching process between the acquired environmental point cloud data and recorded point cloud data, and performing an estimation process to estimate a vehicle position that is a position of the vehicle based on a matching result information of the matching process. The matching process may include a first matching process using a first position as an initial position and a second matching process using a second position different from the first position as an initial position. The matching result information may include a first matched position that is a result of the first matching process and a second matched position that is a result of the second matching process. The estimation process may include at least one of: (a) invalidating at least part of the matching result information in a case that a matching difference information representing the difference between first matched position and second matched position does not satisfy a first condition, and (b) reducing the reliability of the estimated vehicle position obtained by the estimation process compared to in a case that the matching difference information satisfies the first condition.

### Form 9

A vehicle position estimation device (100) comprises a processor and memory storing instructions. The processor is configured to execute the instructions to perform: acquiring environmental point cloud data representing a surrounding environment of a vehicle using sensors mounted to the vehicle, performing a matching process between the acquired environmental point cloud data and recorded point cloud data, and performing an estimation process to estimate a vehicle position that is a position of the vehicle based on a matching result information of the matching process. The matching process may include a first matching process using a first position as an initial position and a second matching process using a second position different from the first position as an initial position. The matching result information may include a first matched position that is a result of the first matching process and a second matched position that is a result of the second matching process. The estimation process may include at least one of: (a) invalidating at least part of the matching result information in a case that a matching difference information representing the difference between first matched position and second matched position does not satisfy a first condition, and (b) reducing the reliability of the estimated vehicle position obtained by the estimation process compared to in a case that the matching difference information satisfies the first condition.

What is claimed is:

1. A vehicle position estimation device comprising:
a point cloud acquisition unit configured to acquire environmental point cloud data representing a surrounding environment of a vehicle using sensors mounted to the vehicle;
a matching unit configured to perform a matching process between the acquired environmental point cloud data and recorded point cloud data; and
an estimation unit configured to perform an estimation process to estimate a vehicle position that is a position of the vehicle based on a matching result information of the matching process,
wherein,
the matching unit is configured to perform, in the matching process, a first matching process using a first position as an initial position and a second matching process using a second position different from the first position as an initial position,
the matching result information includes a first matched position that is a result of the first matching process and a second matched position that is a result of the second matching process, and
in a case that a matching difference information representing the difference between first matched position and second matched position does not satisfy a first condition, the estimation unit performs at least one of: (a) invalidating at least part of the matching result information; and (b) reducing the reliability of the estimated vehicle position obtained by the estimation process compared to in a case that the matching difference information satisfies the first condition.

2. The vehicle position estimation device according to claim 1, wherein
the matching difference information is information of a distance between the first matched position and the second matched position.

3. The vehicle position estimation device according to claim 1, wherein
in a case that the matching difference information does not satisfy the first condition, the matching result information is invalidated, and in a case that a different environmental point cloud data is newly acquired due to a movement of the vehicle, the matching process using newly acquired environmental point cloud data is performed.

4. The vehicle position estimation device according to claim 1, wherein
the first matched position is represented by a first X coordinate value on the X-axis and a first Y coordinate value on the Y-axis perpendicular to the X-axis,
the second matched position is represented by a second X coordinate value on the X-axis and a second Y coordinate value on the Y-axis,
the vehicle position is represented by a vehicle X coordinate value on the X-axis and a vehicle Y coordinate value on the Y-axis,
the matching difference information includes: a difference between the first X coordinate value and a second X coordinate value; and a difference between the first Y coordinate value and the second Y coordinate value,
the first condition is a condition satisfied in a case that at least one of a second condition and a third condition, the second condition relating to the difference between the first X coordinate value and the second X coordinate value, and the third condition relating to the difference between the first Y coordinate value and the second Y coordinate value,
the estimation unit is configured to:
in a case that both the second condition and the third condition are satisfied, perform a first estimation process as the estimation process, the first estimation process being a process to estimate the vehicle X coordinate value and the vehicle Y coordinate value based on a X coordinate value information and a Y coordinate value information, the X coordinate value information including at least one of the first X coordinate value and the second X coordinate value, and the Y coordinate value information including at least one of the first Y coordinate value and the second Y coordinate value;
in a case that the second condition is satisfied and the third condition is not satisfied, perform at least one of: (c) a second estimation process that estimates the vehicle X coordinate value using the X coordinate value information and invalidating the Y coordinate value information, and (d) the first estimation process and
reducing the reliability of the estimated vehicle Y coordinate value compared to the reliability of the estimated vehicle X coordinate value; and
in a case that both the second condition and the third condition are not satisfied, perform at least one of: (a) invalidating at least part of the matching result information, and (b) reducing the reliability of the estimated vehicle position obtained by the estimation process compared to in a case that the matching difference information satisfies the first condition.

5. The vehicle position estimation device according to claim 1, wherein
the matching unit acquires previous matching result information,
the first condition is that the current matching difference information is less than or equal to the previous matching difference information, and
the estimation unit, in a case that the current matching difference information does not satisfy the condition fifth condition, (a) invalidates the present matching result information and estimates the vehicle position using the previous matching result information in the estimation process.

6. The vehicle position estimation device according to claim 1, wherein
the environmental point cloud data includes first environmental point cloud data representing the surrounding environment of a vehicle at a first timing, and second environmental point cloud data representing the surrounding environment of the vehicle at a second timing after the first timing,
when the vehicle travels between the first timing and the second timing, the matching unit:
performs, the first matching process using the first environmental point cloud data and the second matching process using the second environmental point cloud data;
acquires a first provisional position, that is a provisional position of the vehicle at the first timing, and a second provisional position, that is a provisional position at the second timing; and
sets a position based on the first provisional position to the first position and set a position based on the second provisional position to the second position, and
the first position is a deviated position from the first provisional position and/or the second position is a deviated position from the second provisional position.

7. The vehicle position estimation device according to claim 1, wherein
the second position is a position deviated from the first position in the longitudinal direction of the vehicle.

8. A vehicle position estimation method performed by a processor comprising:
acquiring environmental point cloud data representing a surrounding environment of a vehicle using sensors mounted to the vehicle;
performing a matching process between the acquired environmental point cloud data and recorded point cloud data; and
performing an estimation process to estimate a vehicle position that is a position of the vehicle based on a matching result information of the matching process,
wherein,
the matching process includes a first matching process using a first position as an initial position and a second matching process using a second position different from the first position as an initial position,
the matching result information includes a first matched position that is a result of the first matching process and a second matched position that is a result of the second matching process, and
the estimation process includes at least one of: (a) invalidating at least part of the matching result information in a case that a matching difference information representing the difference between first matched position and second matched position does not satisfy a first condition, and (b) reducing the reliability of the estimated vehicle position obtained by the estimation process compared to in a case that the matching difference information satisfies the first condition.
